(19) United States
(12) Patent Application Publication
(10) Pub. No.: US 2023/0409964 A1
(43) Pub. Date: Dec. 21, 2023

(54) LEARNING DEVICE, IDENTIFICATION DEVICE, LEARNING METHOD, IDENTIFICATION METHOD, LEARNING PROGRAM, AND IDENTIFICATION PROGRAM

(71) Applicant: NIPPON TELEGRAPH AND TELEPHONE CORPORATION, Tokyo (JP)

(72) Inventors: Kana KURATA, Tokyo (JP); Yasuhiro YAO, Tokyo (JP); Naoki ITO, Tokyo (JP); Shingo ANDO, Tokyo (JP); Jun SHIMAMURA, Tokyo (JP)

(73) Assignee: NIPPON TELEGRAPH AND TELEPHONE CORPORATION, Tokyo (JP)

(21) Appl. No.: 18/035,090

(22) PCT Filed: Nov. 5, 2020
(86) PCT No.: PCT/JP2020/041433

§ 371 Date: May 2, 2023

(51) Int. Cl. G06N 20/00

(52) U.S. Cl. CPC G06N 20/00

(57) ABSTRACT

An identification device acquires a plurality of identification target points by sampling a target point group that is a set of three-dimensional target points. The identification device calculates relative coordinates of a neighboring point of the identification target point with respect to the identification target point. The identification device inputs coordinates of the plurality of identification target points and relative coordinates of neighboring points with respect to each of the plurality of identification target points into a class label assigning learned model to acquire class labels of the plurality of identification target points and validity of the class labels with respect to the neighboring points for each of the plurality of identification target points. The identification device assigns the class labels to the plurality of identification target points, assigns the class labels to the neighboring points for each of the plurality of identification target points when the validity of the class label is included in a range determined by a predetermined threshold value, and identifies the class labels of the identification target point and the neighboring point.

### TECHNICAL FIELD

The disclosed technology relates to a learning device, an identification device, a learning method, an identification method, a learning program, and an identification program.

### BACKGROUND ART

The surface of an object is represented by three-dimensional points having three-dimensional position information (x, y, z). Data including such a group of three-dimensional points is referred to as a three-dimensional point group. The three-dimensional point group is a set of N (N≥2) points, and each point is specified by an identifier of 1 to N. The three-dimensional point group is a plurality of points on the surface of the object, and is also data indicating geometric information of the object.

The three-dimensional point group representing the object is acquired by measurement by a distance sensor or three-dimensional reconstruction on an image of the object. In addition, attribute information may be assigned to the three-dimensional points. The attribute information of the three-dimensional points is information different from the position information obtained at the time of measuring the point group, and examples thereof include an intensity value indicating reflection intensity of a point and an RGB value indicating color information of a point.

In addition, a class label may be assigned to the three-dimensional point group. The class label of the three-dimensional point group is information for identifying the type (or class) of the object represented by the three-dimensional point group. Examples of such a class label include a class label indicating ground, a building, a pillar, a cable, a tree, and the like when an outdoor three-dimensional point group is targeted.

In a three-dimensional point group (hereinafter, simply referred to as “scene data”) including points belonging to a plurality of classes such as a street and a room, it is possible to specify the type and boundary of an object included in a scene by identifying each point.

The identification in this case is to assign class labels as attribute values to each point included in the three-dimensional point group.

Assigning class labels to each point included in the three-dimensional point group is referred to as semantic segmentation. Even in the case of a single object, the act of assigning different class labels to each part of the object corresponds to semantic segmentation. Semantic segmentation is performed based on the feature quantity extracted from the three-dimensional point group.

In recent years, a method in which feature extraction based on relative coordinates of neighboring points is performed stepwise by a deep neural network (hereinafter, simply referred to as “DNN”), and feature quantities of an object shape at a plurality of distance scales obtained by the feature extraction are used to identify class labels of each point has become known (for example, refer to Non Patent Literature 1 and 2).

For example, DNN described in Non Patent Literature 1 repeats selection of a representative point and convolution of a feature quantity of a neighboring point with respect to the representative point by X-Convolution. This DNN is provided with a downsampling layer for selecting a smaller number of representative points than the previous layer and performing processing and an upsampling layer for selecting a larger number of points than the previous layer, thereby outputting class labels of each point based on feature quantities at a plurality of distance scales.

In addition, the DNN described in Non Patent Literature 2 repeats convolution of a feature quantity by parametric continuous convolution. This DNN assigns class labels to each point based on feature quantities obtained by two spatial scales. Specifically, this DNN assigns class labels to each point based on feature quantities acquired for each point of the three-dimensional point group and feature quantities based on a wide-area object shape obtained by pooling all the points of the three-dimensional point group.

### CITATION LIST

### Non Patent Literature

Non Patent Literature 1: Y. Li, R. Bu, M. Sun, W. Wu, X. Di, B. Chen, “PointCNN: Convolution On X-Transformed Points”, pp. 828-838, 2018.

Non Patent Literature 2: Shenlong Wang, Simon Suo, Wei-Chiu Ma, Andrei Pokrovsky, and Raquel Urtasun. 2018. Deep Parametric Continuous Convolutional Neural Networks. CVPR (2018).

### SUMMARY OF INVENTION

### Technical Problem

The neighboring points in Non Patent Literature 1 and 2 are determined from among identification target points. FIG. 11 illustrates a conceptual diagram of neighboring points and convolution of features of identification target points and the neighboring points. As illustrated in FIG. 11, for example, a feature quantity F_i of the i-th identification target point is acquired by performing convolution integration on the feature quantity of the j-th neighboring point located in the vicinity of the i-th identification target point by using a coefficient corresponding to relative coordinates Y_ij. Alternatively, the relative coordinates Y_ij may be converted such that the relative coordinates Y_ij are ranked according to the distance to the identification target point. Note that i is an index indicating an identification target point, and j is an index indicating the vicinity of the identification target point. However, the value of j does not necessarily indicate the order of closeness of the distance.

The technologies described in Non Patent Literature 1 and 2 have an advantage that it is possible to identify class labels of each point based on feature quantities obtained at a plurality of distance scales. Specifically, in the technologies described in Non Patent Literature 1 and 2, when a feature quantity is computed with a wide-area distance scale, the feature quantity is computed based on all the points included in a target range. In addition, in the technologies described in Non Patent Literature 1 and 2, when a three-dimensional point group having a fixed number of points is received, identification of class labels for each point of the three-dimensional point group is processed by the GPU, thereby realizing a practical processing time.

When the semantic segmentation model based on the feature quantity at a plurality of distances is executed for a three-dimensional point group (10⁷ points or less) having a high density and a spatially wide area, there are many restrictions on the RAM capacity and the like. Therefore, when the semantic segmentation is performed on a wide-area three-dimensional point group, pre-processing of division and sampling is performed on the three-dimensional point group. Then, the semantic segmentation is generally performed on an identification target point group including a certain number of points (10⁴ points or less) obtained by the pre-processing. Note that, when a scene in which the size of an object is wide, such as outdoors, is targeted, the division size is kept relatively large (50 m³ or more) in order to prevent the object from being cut into pieces by finely dividing the three-dimensional point group.

In addition, by reducing the number of samples of sampling on the three-dimensional point group, the number of samples is converted into the number of processable points. Note that, in a case where the size of division when the three-dimensional point group is divided is constant, the number of samples is proportional to the density of the point group.

When the number of samples is reduced as described above, two problems occur.

First, it is difficult to identify a three-dimensional point on an object having a complicated shape. This is because the detailed shape expressed in the high-density three-dimensional point group disappears due to the division of the three-dimensional point group.

Second, in a case where a class label is assigned to an unidentified point based on class labels of a small number of sample points, erroneous identification occurs near an object boundary. For example, the nearest neighbor algorithm can be used to assign a class label to an unidentified point. However, in a case where a point having the shortest distance among the sample points exists on a different object such as an object boundary, erroneous identification may occur.

Therefore, in the technologies of the related art, there is a problem that it is not possible to accurately identify a class label of a three-dimensional point in a case where the class label is assigned to the three-dimensional point sampled from the three-dimensional point group.

The disclosed technology has been made in view of the above points, and an object thereof is to accurately identify a class label of a three-dimensional point even when the class label is assigned to the three-dimensional point sampled from a three-dimensional point group.

### Solution to Problem

According to a first aspect of the present disclosure, there is provided a learning device including: a learning data acquisition unit that acquires learning data in which coordinates of a learning identification target point sampled from a learning target point group that is a set of three-dimensional target points for learning, relative coordinates of a learning neighboring point set for the learning identification target point with respect to the identification target point, teacher data of a class label of the learning identification target point, and teacher data of validity of the class label of the learning identification target point are associated with each other; and a learning unit that learns a class label assigning model including a first model for inputting the relative coordinates of the neighboring point set for the identification target point with respect to the identification target point and outputting conversion coordinates obtained by converting the relative coordinates of the neighboring point and a first feature quantity, a second model for inputting the coordinates of the identification target point and the first feature quantity and outputting a second feature quantity and the class label of the identification target point, and a third model for inputting the second feature quantity and the conversion coordinates obtained by converting the relative coordinates of the neighboring point and outputting validity of the class label for the neighboring point, based on the learning data acquired by the learning data acquisition unit, to generate a class label assigning learned model for inputting the coordinates of the identification target point and the relative coordinates of the neighboring point and outputting the validity of the class label of the identification target point and the class label for the neighboring point.

### Advantageous Effects of Invention

According to the disclosed technology, it is possible to accurately identify a class label of a three-dimensional point even when the class label is assigned to the three-dimensional point sampled from a three-dimensional point group.

### BRIEF DESCRIPTION OF DRAWINGS

FIG. 1 is a diagram showing an example of a class label assigning model according to a first embodiment.

FIG. 2 is a block diagram showing a hardware configuration of a learning device 10 according to the first embodiment.

FIG. 3 is a block diagram showing an example of a functional configuration of the learning device 10 according to the first embodiment.

FIG. 4 is a block diagram showing a hardware configuration of an identification device 20 according to the first embodiment.

FIG. 5 is a block diagram showing an example of a functional configuration of the identification device 20 according to the first embodiment.

FIG. 6 is a flowchart showing a flow of learning processed by the learning device 10 according to the first embodiment.

FIG. 7 is a flowchart showing a flow of identification processing by the identification device 20 according to the first embodiment.

FIG. 8 is a block diagram showing an example of a functional configuration of an identification device 212 according to a second embodiment.

FIG. 9 is a block diagram showing an example of a model used in the second embodiment.

FIG. 10 is a modification example of a class label assigning model according to the second embodiment.

FIG. 11 is a diagram for describing a conventional technique.

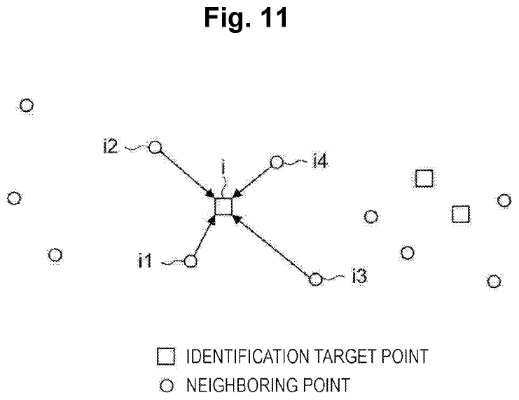

### DESCRIPTION OF EMBODIMENTS

Hereinafter, an example of an embodiment of the disclosed technique will be described with reference to the drawings. In the drawings, the same or equivalent constituents and portions are denoted by the same reference numerals. Dimensional ratios in the drawings are exaggerated for convenience of description, and may be different from actual ratios.

### First Embodiment

In a first embodiment, a class label indicating what the three-dimensional point represents is assigned to the three-dimensional point included in the three-dimensional point group. At that time, in the first embodiment, the class label is assigned to the three-dimensional point in consideration of the position of the neighboring point in the vicinity of the three-dimensional point to which the class label is assigned. The neighboring point is a three-dimensional point of which the spatial distribution position is close to the identification target point, which is extracted by a method such as a method in which a Euclidean distance in a real space to the three-dimensional point is shorter than a predetermined distance and falls within a predetermined order when the distance to the identification target point is ranked, or the like. This neighboring point group is set by a method of setting any number of three-dimensional points in ascending order of the distance to the target three-dimensional point. Alternatively, this neighboring point group can also be set by a method of setting a three-dimensional point within any distance from the target three-dimensional point.

Furthermore, in the first embodiment, validity of a class label indicating whether or not a class label assigned to a three-dimensional point may also be assigned to a neighboring point of the three-dimensional point is calculated. Then, in the present embodiment, it is determined whether or not a similar class label may be assigned to neighboring points based on the validity of the class label. In the first embodiment, the class label and the validity of the class label are calculated by using relative coordinates of neighboring points with respect to the target three-dimensional point to which the class label is assigned. Relative coordinates of a neighboring point with respect to an identification target point, which is a three-dimensional point to which a class label is assigned, are calculated according to the following Formula (1).

Y_ij=X_i−Z_ij (1)

Here, i is an index (1≤i≤Q, Q is the total number of identification target points) indicating an identification target point. ij is an index (1≤j≤K_i, K_i is the total number of neighboring points for the identification target point) of the j-th neighboring point with respect to the i-th identification target point. X_i is the coordinates of the identification target point, and Y_ij is the relative coordinates of a neighboring point with respect to the identification target point. Z_ij is the coordinates of a neighboring point. The coordinates of each point are a D-dimensional array. Since D=3 in the three-dimensional point group, D=3 in the present embodiment will be described below. In a case where the processing is performed after the three-dimensional point group is two-dimensionally projected or the like, D=2.

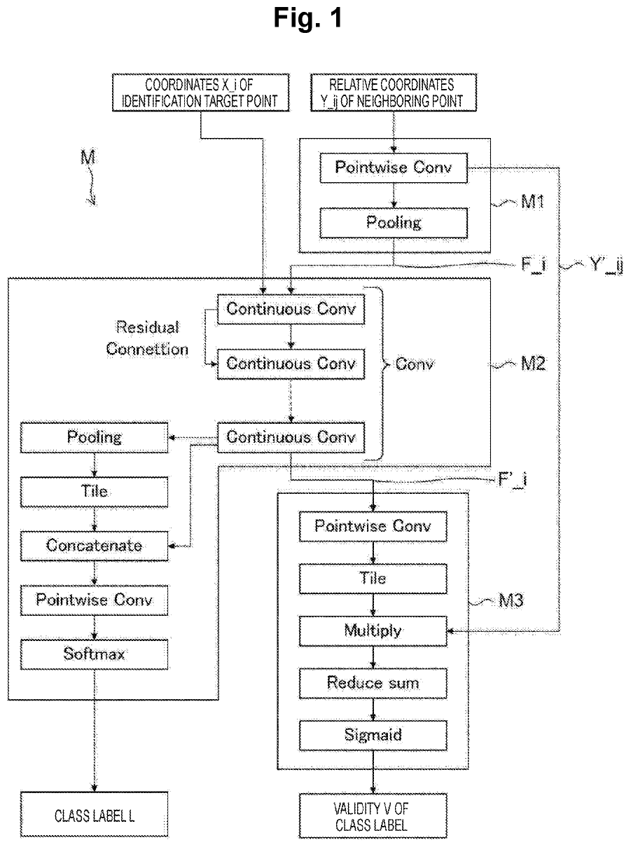

In the first embodiment, a class label and validity of the class label are calculated by using a class label assigning model obtained by machine learning. FIG. 1 is a diagram showing an example of the class label assigning model according to the first embodiment. As illustrated in FIG. 1, a class label assigning model M includes a DNN module M1 which is an example of a first model, a DNN module M2 which is an example of a second model, and a DNN module M3 which is an example of a third model.

The DNN module M1 which is an example of the first model is realized by, for example, an aggregative input convolution network (AIC). Furthermore, the DNN module M2 is realized by including a deep neural network (DNN) that performs semantic segmentation of a three-dimensional point group based on feature quantities at a plurality of distance scales. In addition, the DNN module M3 functions as a label validity estimation network.

In the first embodiment, an identification target point is specified by sampling from a high-density three-dimensional point group observed in advance. The number of three-dimensional points included in the three-dimensional point group is approximately 10⁶ points, whereas the number of identification target points is approximately 10⁴ points.

The class label assigning model according to the first embodiment outputs the class label and the validity (for example, a value of 0 to 1) of the class label with respect to a neighboring point of each identification target point, for each identification target point. Then, in the first embodiment, the same class label as the class label assigned to each identification target point is assigned to a neighboring point having a high value of class label validity (for example, a value exceeds any set threshold value). As a result, when a class label is assigned to a three-dimensional point sampled from a three-dimensional point group, it is determined whether the same class label as the identification target point may be assigned to the neighboring point, and the class label of the three-dimensional point can be accurately identified.

Hereinafter, a specific description will be made.

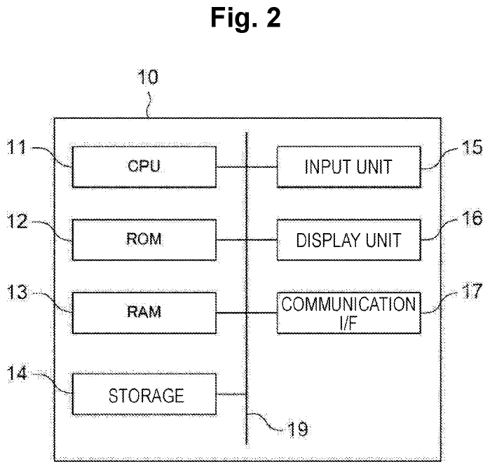

FIG. 2 is a block diagram showing a hardware configuration of a learning device 10.

As illustrated in FIG. 2, the learning device 10 includes a central processing unit (CPU) 11, a read only memory (ROM) 12, a random access memory (RAM) 13, a storage 14, an input unit 15, a display unit 16, and a communication interface (I/F) 17. The constituents are connected to each other via a bus 19 to be capable of communicating with each other.

The CPU 11 is a central processing unit, and executes various programs and controls each unit. That is, the CPU 11 reads the program from the ROM 12 or the storage 14, and executes the program by using the RAM 13 as a work region. The CPU 11 performs control of each of the above-described constituents and various types of arithmetic processing according to the programs stored in the ROM 12 or the storage 14. In the first embodiment, a learning program for learning a model for assigning a class label is stored in the ROM 12 or the storage 14.

The ROM 12 stores various programs and various types of data. The RAM 13 temporarily stores programs or data as a work region. The storage 14 includes a storage device such as a hard disk drive (HDD) or a solid state drive (SSD), and stores various programs including an operating system and various types of data.

The input unit 15 includes a pointing device such as a mouse and a keyboard, and is used to perform various inputs.

The display unit 16 is, for example, a liquid crystal display, and displays various types of information. The display unit 16 may function as the input unit 15 by adopting a touch panel system.

The communication interface 17 is an interface for communicating with another device. For the communication, for example, a wired communication standard such as Ethernet (registered trademark) or FDDI, or a wireless communication standard such as 4G, 5G, or Wi-Fi (registered trademark) is used.

Next, functional configurations of the learning device 10 will be described.

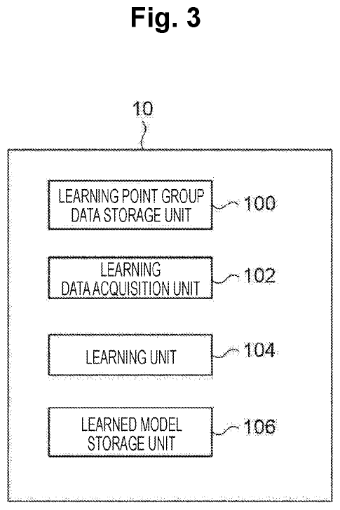

FIG. 3 is a block diagram showing an example of the functional configuration of the learning device 10.

As illustrated in FIG. 3, the learning device 10 includes a learning point group data storage unit 100, a learning data acquisition unit 102, a learning unit 104, and a learned model storage unit 106 as functional configurations. Each functional configuration is realized by the CPU 11 reading a learning program stored in the ROM 12 or the storage 14, developing the learning program in the RAM 13, and executing the learning program.

The learning point group data storage unit 100 stores learning data used when a model for assigning a class label to a three-dimensional point is learned. The learning data is data in which coordinates of a learning identification target point, relative coordinates of a learning neighboring point with respect to the identification target point, teacher data of a class label of the learning identification target point, and teacher data of validity of the class label of the learning identification target point are associated with each other.

Note that the learning identification target point is data sampled from a learning target point group that is a set of three-dimensional target points for learning. In addition, the learning neighboring point is a three-dimensional point of which the spatial distribution position is close to the identification target point, which is extracted by a method such as a method in which a distance to the learning identification target point is shorter than a predetermined distance and falls within a predetermined order when the distance to the learning identification target point is ranked, or the like.

The learning data acquisition unit 102 acquires learning data stored in the learning point group data storage unit 100.

The learning unit 104 causes the class label assigning model to perform machine learning based on the learning data acquired by the learning data acquisition unit 102. As illustrated in FIG. 1, a class label assigning model M includes a DNN module M1 which is an example of a first model, a DNN module M2 which is an example of a second model, and a DNN module M3 which is an example of a third model.

Note that each layer (for example, “Pointwise Conv”) included in the DNN module M1, the DNN module M2, and the DNN module M3 illustrated in FIG. 1 is realized by a known technology. Note that the Conv part of the DNN module M2 is realized by eight layers of “Continuous Conv”.

As illustrated in FIG. 1, the DNN module M1 uses the relative coordinates Y_ij of a plurality of neighboring points set for the identification target point with respect to the identification target point as inputs. Furthermore, the DNN module M1 outputs conversion coordinates Y′_ij obtained by converting the relative coordinates Y_ij of the plurality of neighboring points and a first feature quantity F_i of the identification target point. The first feature quantity F_i is a feature quantity based on the local shape of the object expressed by the distribution of the plurality of neighboring points. Note that the first feature quantity F_i is an array having Q×C_1 elements. C_1 is any natural number. The conversion coordinates Y′_ij of the neighboring point is an array having D′×ΣK_i elements. Note that 1≤i≤Q, and D′ is any natural number.

The conversion coordinates Y′_ij output from the DNN module M1 are output to the DNN module M3. In addition, the first feature quantities F_i of the plurality of identification target points output from the DNN module M1 are output to the DNN module M2. When the point group data has an attribute such as luminance data or RGB data, the DNN module M1 may be configured to be able to input attribute values As of the plurality of identification target points and attribute values An of the plurality of neighboring points. In this case, these attribute values may be used to compute the relative coordinates Y_ij of the neighboring points and the first feature quantity F_i. In this case, the attribute values As of the plurality of identification target points are an array having Q×C_0 elements. The attribute values An of the plurality of neighboring points are an array having C_0×ΣK_i elements. Note that C_0 is the number of dimensions of the array of the attribute values themselves. Note that the method of inputting the attribute value is not limited thereto. For example, a method of combining a channel of an attribute value with the first feature quantity F_i may be adopted.

In a case where an aggregative input convolution network is adopted as the DNN module M1, the DNN module M1 has a layer for calculating the conversion coordinates Y′_ij of the neighboring point from the relative coordinates Y_ij of the j-th neighboring point with respect to the i-th identification target point according to the following Formula (2). Furthermore, in this case, the DNN module M1 also includes a layer for calculating the first feature quantity F_i of the i-th identification target point from the relative coordinates Y_ij of the j-th neighboring point with respect to the i-th identification target point according to the following Formula (3). The first feature quantity F_i and the conversion coordinates Y′_ij computed in this case are based on the local object shape expressed by the distribution of the plurality of neighboring points with respect to the identification target point.

[Math. 1]

Y′_ij [symbol] g_0(Y_ij) (2)

F_i=Pooling(g_1(Y_ij)) (3)

g_0 and g_1 in the above formula are multilayer perceptrons, and parameters thereof are set by machine learning. In the multilayer perceptron, the arithmetic operation on the relative coordinates Y_ij of each neighboring point is converted independently for each point by using convolution calculation in the channel direction (the elements of the array in this case have D elements or D+C_0 elements) and an activation function such as ReLu. The same parameters may be used for g_0 and g_1.

Pooling in the above formula is a pooling function. The pooling function performs pooling over all the neighboring points at each identification target point. As a pooling method, for example, maximum value pooling or average value pooling is used. g_1(Y_ij) to which a K_i×D′-dimensional array is output at each identification target point is converted into a D′-dimensional array by pooling.

Note that, in a case where the attribute value An of the neighboring point is also input, for example, it is possible to use the array YA_ij obtained by combining the relative coordinates Y_ij of the neighboring point and the attribute value A_ij of the neighboring point instead of the relative coordinates Y_ij, or use the array YA_ij instead of the relative coordinates Y_ij only for the computation of the first feature quantity F_i. Note that this array YA_ij is an array having K_i×(D+C_0) elements.

Furthermore, the DNN module M2 uses the coordinates X_i of the identification target point and the first feature quantity F_i of the identification target point output from the DNN module M1 as inputs. Note that 1≤i≤Q, a set of coordinates X_i of the identification target points is X, and a set of first feature quantities F_i of the identification target points is F. The set X of coordinates of the identification target points and the set F of first feature quantities of the identification target points are input into M2, and a second feature quantity F′_i of the identification target point and the class label L_i of the identification target point with respect to the coordinates X_i of each identification target point are output. Note that a set of the class labels L_i of the identification target points with respect to the coordinates X_i of each identification target point is L.

A set F′ of the second feature quantities is an array having Q×C_2 elements, and C_2 is the number of dimensions of the array of the feature quantities themselves. In addition, a set L of class labels for the plurality of identification target points is an array having Q×U elements, and U is the number of identification target classes. In addition, the set L of class labels is output to a label assignment unit 208 described later.

The set F′ of the second feature quantities is output to the DNN module M3. When the identification target point has an attribute such as luminance data or RGB data, the DNN module M2 may be configured to be able to receive the input of the attribute values As of the plurality of identification target points. In this case, the attribute values As of the plurality of identification target points can be used to compute the set F′ of the second feature quantities. Note that, for example, the DNN module M2 is realized by the technologies disclosed in Non Patent Literature 1 and Non Patent Literature 2. The DNN module M2 of FIG. 1 is realized by the technology disclosed in Non Patent Literature 2.

Furthermore, the DNN module M3 uses the conversion coordinates Y′_ij of the neighboring point output from the DNN module M1 and the second feature quantity F′_i of the identification target point output from the DNN module M2 as inputs. Then, the DNN module M3 outputs the validity V of the class label L for each of the plurality of neighboring points with respect to each of the plurality of identification target points. The validity V_i of the class label L_i of the i-th identification target point with respect to the j-th neighboring point is an array having ΣK_i elements.

The DNN module M3 outputs the validity V_ij of the class label for the j-th neighboring point of the i-th identification target point based on the relative coordinates Y_ij of the neighboring point output from the DNN module M1 and the second feature quantity F′_i output from the DNN module M2. For example, the validity V_ij of the class label for the j-th neighboring point of the i-th identification target point can be computed according to the following Formula (4). The validity V_ij of the class label is a scalar value.

[Math. 2]

V_ij=Sigmoid(h(F′_i)⊙Y′_ij) (4)

Further, h represents a multilayer perceptron, and parameters thereof are set by machine learning. In the multilayer perceptron, the second feature quantity F′_i of each identification target point is converted into an array (this array has the same size as Y′_ij) having a channel of D′ independently for each point by using convolution calculation in a channel direction (the elements of the array in this case have C_2 elements) and an activation function such as ReLu.

Further,

⊙ [Math. 3]

represents the arithmetic operation of the element product of the vector. Sigmoid represents a sigmoid function. Sigmoid receives any real value as an input and outputs a real value of 0 to 1.

Note that the above Formula (4) is an example of a function that changes a value according to the degree of possibility of the same class label being assigned to the identification target point and the neighboring point.

The learning unit 104 causes the class label assigning model M as illustrated in FIG. 1 to perform machine learning. As a result, when the set X of the coordinates of the plurality of identification target points and the set Y of relative coordinates of the plurality of neighboring points with respect to each of the identification target points included in X, a class label assigning learned model for outputting the set L of class labels of the plurality of identification target points and the set V of validity for each element of the class label L with respect to the plurality of neighboring points is generated.

Specifically, the learning unit 104 causes the machine learning of the class label assigning model to minimize a loss function Loss indicated in the following Formula (5) with respect to the learning data corresponding to the i-th learning identification target point among the plurality of learning identification target points by using the gradient method or the like. As a result, a class label assigning learned model is generated.

$$\begin{matrix}[ Math . 4 ] & \\ Loss = CE ( L\_i , Lt\_i ) + r / K\_i \times {\sum }_{j = 1}^{K\_i} ( SE ( V\_ij , Vt\_ij ) ) & ( 5 )\end{matrix}$$

The loss function Loss is an example of a function that measures a deviation between the set L of class labels of learning identification target points output from the class label assigning model during learning or before learning and a set Lt of teacher data representing a correct answer value of the set L of class labels, and a deviation between the set V of validity of the set L of class labels output from the class label assigning model during learning or before learning and a set Vt of teacher data representing a correct answer value of the set V of validity of the set L of class labels of the learning neighboring points.

The set Vt of teacher data is data indicating the identity between the class label of each identification target point and the class label of the neighboring point. The set Vt of teacher data is an array having ΣK_i elements. The set Vt of teacher data is generated in advance based on the class labels of the plurality of identification target points in the learning data and the class labels of the neighboring points thereof. The element Vt_ij of the set Vt of teacher data is data having a high value when the class label of the neighboring point is the same as the identification target point. For example, the value can be 1 when the class label of the neighboring point is the same as that of the identification target point, and the value can be 0 when the class label of the neighboring point is different from that of the identification target point.

L_i is a class label for the i-th learning identification target point output from the class label assigning model during learning or before learning. Further, Lt_i is teacher data representing a correct answer value of a class label corresponding to the i-th learning identification target point. Lt_i represents a class label of a plurality of identification target points in the learning data by a one-hot vector. Therefore, Lt, which is a set of Lt_i, is an array having Q×U elements. Note that U is the total number of identification target classes.

CE is the average of the cross entropy between L_i and Lt_i. r is a preset learning coefficient. V_ij is validity of a class label of the j-th learning neighboring point for the i-th learning identification target point, which is output from the class label assigning model during learning or before learning. Vt_ij is teacher data representing a correct answer value of the validity of the class label corresponding to the j-th learning neighboring point for the i-th learning identification target point. SE is the square error between V_ij and Vt_ij.

The learning unit 104 minimizes the loss function Loss by using the gradient method or the like until the end condition of the iterative calculation is satisfied. As the end condition of the iterative calculation, for example, it is possible to set the loss function Loss to be below any threshold value (for example, a positive real number), the variation of the loss function to be below any threshold value (positive real number), the number of repetitions to exceed any threshold value (natural number), and the like. Note that the learning unit 104 can use an optimizer such as Adam when updating the class label assigning learned model.

Then, the learning unit 104 stores the class label assigning learned model in the learned model storage unit 106.

The learned model storage unit 106 stores the class label assigning learned model generated by the learning unit 104. Note that the learned model storage unit 106 stores parameters of the class label assigning learned model and data representing the network structure thereof as a class label assigning learned model.

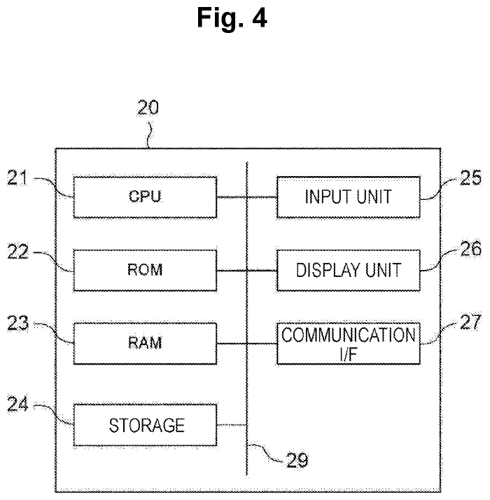

FIG. 4 is a block diagram showing a hardware configuration of an identification device 20.

As illustrated in FIG. 4, the identification device 20 includes a central processing unit (CPU) 21, a read only memory (ROM) 22, a random access memory (RAM) 23, a storage 24, an input unit 25, a display unit 26, and a communication interface (I/F) 27. The constituents are connected to each other via a bus 29 to be capable of communicating with each other.

The CPU 21 is a central processing unit, and executes various programs and controls each unit. That is, the CPU 21 reads the program from the ROM 22 or the storage 24, and executes the program using the RAM 23 as a work region. The CPU 21 performs control of each of the above-described constituents and various types of arithmetic processing according to a program stored in the ROM 22 or the storage 24. In the first embodiment, an identification program for assigning a class label is stored in the ROM 22 or the storage 24.

The ROM 22 stores various programs and various types of data. The RAM 23 temporarily stores programs or data as a work region. The storage 24 includes a storage device such as a hard disk drive (HDD) or a solid state drive (SSD), and stores various programs including an operating system and various types of data.

The input unit 25 includes a pointing device such as a mouse and a keyboard, and is used to perform various inputs.

The display unit 26 is, for example, a liquid crystal display, and displays various types of information. The display unit 26 may function as the input unit 25 by adopting a touch panel system.

The communication interface 27 is an interface for communicating with another device. For the communication, for example, a wired communication standard such as Ethernet (registered trademark) or FDDI, or a wireless communication standard such as 4G, 5G, or Wi-Fi (registered trademark) is used.

Next, each functional configuration of the identification device 20 will be described.

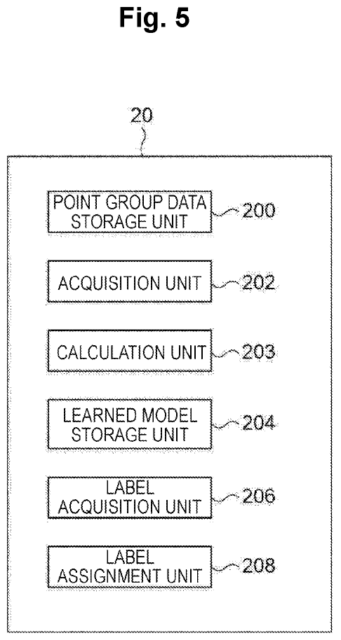

FIG. 5 is a block diagram showing an example of the functional configuration of the identification device 20.

As illustrated in FIG. 5, the identification device 20 includes a point group data storage unit 200, an acquisition unit 202, a calculation unit 203, a learned model storage unit 204, a label acquisition unit 206, and a label assignment unit 208 as functional configurations. Each functional configuration is realized by the CPU 21 reading an identification program stored in the ROM 22 or the storage 24, developing the identification program in the RAM 23, and executing the identification program.

The point group data storage unit 200 stores a target point group that is a set of three-dimensional target points.

The acquisition unit 202 acquires a plurality of identification target points (1≤i≤Q, Q is the total number of identification target points) by sampling the target point group stored in the point group data storage unit 200. In addition, the acquisition unit 202 acquires a plurality of neighboring points (1≤j≤K_i, K_i is the total number of neighboring points for the identification target point) set for the identification target point from the point group data storage unit 200, for each of the plurality of identification target points.

For example, the acquisition unit 202 samples a plurality of identification target points from the target point group by performing a known sampling algorithm on the target point group. Examples of the sampling method include random sampling and inverse density sampling. The neighboring points of the identification target point at this time are determined from a high-density D-dimensional point group before sampling.

Note that, when the identification target point is input into the class label assigning learned model, the identification target point is an array having Q×D elements. In addition, when the neighboring point is input into the class label assigning learned model to be described later, an array having D×ΣK_i elements is obtained.

In addition, in a case where an attribute such as luminance data or RGB data is assigned to the target point group, it is also possible to input the attribute values As of the plurality of identification target points and the attribute values An of the neighboring points thereof into the class label assigning learned model to be described later.

The calculation unit 203 calculates the relative coordinates Y_ij for the identification target point, for each of the plurality of neighboring points for the plurality of identification target points acquired by the acquisition unit 202.

The learned model storage unit 204 stores the class label assigning learned model learned by the learning device 10.

The label acquisition unit 206 inputs the set X of the coordinates X_i of the plurality of identification target points and the set Y of the relative coordinates Y_ij of the plurality of neighboring points of the identification target points into the class label assigning learned model stored in the learned model storage unit 204, thereby acquiring the set L of class labels of the identification target points and the set V of validity of the set L of class labels of the identification target points for the plurality of neighboring points.

The label assignment unit 208 assigns the class label L_i acquired by the label acquisition unit 206 to the i-th identification target point, and assigns the class label L_i to the plurality of neighboring points when the validity V_ij of the class label L_i is included in a range defined by a predetermined threshold value. For example, when the validity V_ij of the class label L_i is 0.8 to 1.0, the label assignment unit 208 assigns the class label L_i of the identification target point to the neighboring point. Alternatively, the label assignment unit 208 may assign the class label L_i of the identification target point to the neighboring point when the validity V_ij of the class label L_i is 0.8 or more.

Next, actions of the learning device 10 will be described.

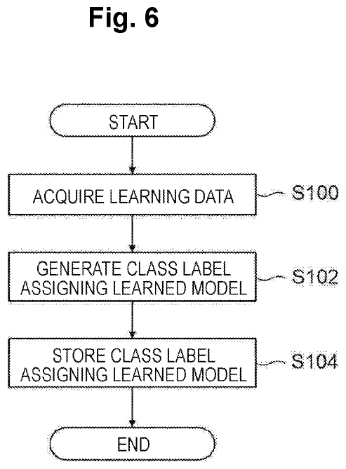

FIG. 6 is a flowchart showing a flow of learning processing by the learning device 10. Learning processing is performed by the CPU 11 reading a learning program from the ROM 12 or the storage 14, developing the learning program in the RAM 13, and executing the learning program.

In step S100, the CPU 11, as the learning data acquisition unit 102, acquires a plurality of pieces of learning data stored in the learning point group data storage unit 100.

In step S102, the CPU 11 causes the learning unit 104 to perform machine learning on the class label assigning model to minimize the loss function Loss in the above Formula (5) based on the plurality of pieces of learning data acquired in step S100, thereby generating a class label learned model.

In step S104, the CPU 11 stores, as the learning unit 104, the class label assigning learned model generated in step S102 in the learned model storage unit 106, and ends a learning processing routine.

Next, actions of the identification device 20 will be described. After the class label assigning learned model is generated by the learning processing by the learning device 10 and stored in the learned model storage unit 106, the class label assigning learned model is input into the identification device 20.

Upon receiving the class label assigning learned model, the identification device 20 stores the class label assigning learned model in its own learned model storage unit 204. Then, when an instruction signal for starting the processing of assigning a class label to a plurality of identification target points is received, the identification processing is executed.

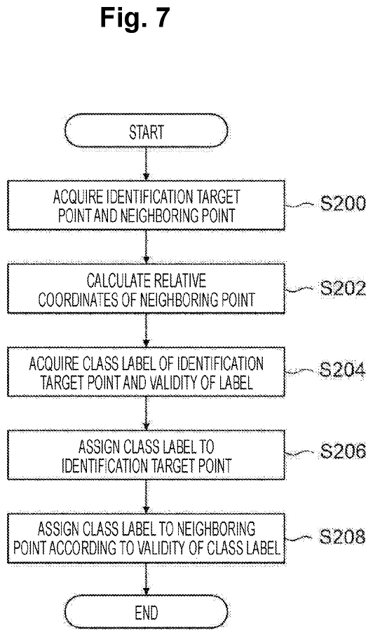

FIG. 7 is a flowchart showing a flow of identification processing by the identification device 20. Identification processing is performed by the CPU 21 reading an identification program from the ROM 22 or the storage 24, developing the identification program in the RAM 23, and executing the identification program.

In step S200, the acquisition unit 202 acquires the plurality of identification target points by sampling the target point group stored in the point group data storage unit 200. The acquisition unit 202 also acquires neighboring points of the identification target point from the point group data storage unit 200, for each of the plurality of identification target points.

In step S202, the CPU 21, as the calculation unit 203, calculates the relative coordinates Y_ij of the neighboring point for each of the plurality of neighboring points for each of the plurality of identification target points acquired in step S200.

In step S204, the CPU 21 inputs, as the label acquisition unit 206, the coordinates X_i of the plurality of identification target points acquired in step S100 and the relative coordinates Y_ij of the plurality of neighboring points for each identification target point calculated in step S202 into the class label assigning learned model stored in the learned model storage unit 204. Then, the label acquisition unit 206 acquires the class label L_i of the plurality of identification target points and the validity V_ij of the class label L_i for the plurality of neighboring points.

In step S206, the CPU 21, as the label assignment unit 208, assigns the class label L_i acquired in step S204 to the identification target point.

In step S208, when the validity V_ij of the class label L_i acquired in step S204 is included in a predetermined range, the CPU 21, as the label assignment unit 208, assigns the class label L_i to a neighboring point of the corresponding identification target point.

As described above, the learning device according to the first embodiment acquires learning data in which coordinates of a learning identification target point sampled from a learning target point group that is a set of three-dimensional target points for learning, relative coordinates of a learning neighboring point set for the learning identification target point with respect to the identification target point, teacher data of a class label of the learning identification target point, and teacher data of validity of the class label of the learning identification target point are associated with each other. In addition, the learning device learns a class label assigning model including a first model for inputting the relative coordinates of the neighboring point set for the identification target point with respect to the identification target point and outputting conversion coordinates obtained by converting the relative coordinates of the neighboring point and a first feature quantity, a second model for inputting the coordinates of the identification target point and the first feature quantity and outputting a second feature quantity and the class label of the identification target point, and a third model for inputting the second feature quantity and the conversion coordinates obtained by converting the relative coordinates of the neighboring point and outputting validity of the class label for the neighboring point, based on the learning data. In addition, the learning device generates a class label assigning learned model for inputting the coordinates of the identification target point and the relative coordinates of the neighboring point and outputting the validity of the class label of the identification target point and the class label for the neighboring point.

In addition, the identification device according to the first embodiment acquires a plurality of identification target points by sampling a target point group that is a set of three-dimensional target points. In addition, the identification device calculates relative coordinates of a neighboring point set for the identification target point with respect to the identification target point, for each of the plurality of acquired identification target points. The identification device acquires class labels of the plurality of identification target points and validity of the class labels of each of the plurality of identification target points with respect to the neighboring points by inputting coordinates of the plurality of identification target points and the relative coordinates of the neighboring points with respect to each of the plurality of identification target points into the class label assigning learned model generated by the learning device. In addition, the identification device assigns the class label to the plurality of identification target points, assigns the class labels to the neighboring points for each of the plurality of identification target points when the validity of the class label is equal to or greater than a predetermined threshold value, and identifies the class labels of the identification target points and the neighboring points. As a result, it is possible to accurately identify a class label of a three-dimensional point even when the class label is assigned to the three-dimensional point sampled from a three-dimensional point group. Specifically, the learned DNN module M3 determines whether or not a similar class label to the identification target point may be assigned to the neighboring point in consideration of the neighboring point different from the identification target point. As a result, even in a case where a point having the shortest distance among the sample points exists on different objects such as an object boundary, erroneous identification can be reduced.

In addition, by assigning a class label based on feature quantities at a plurality of distance scales regarding a group of high-density three-dimensional points, it is possible to suppress erroneous assignment of a class label to a neighboring point belonging to a class different from that of an identification target point around the identification target point near an object boundary.

### Second Embodiment

Next, a second embodiment will be described. The second embodiment is different from the first embodiment in that class labels are assigned to all the target points included in the target point group based on the set F′ of second feature quantities and the set L of class labels for each of the plurality of identification target points calculated in the first embodiment.

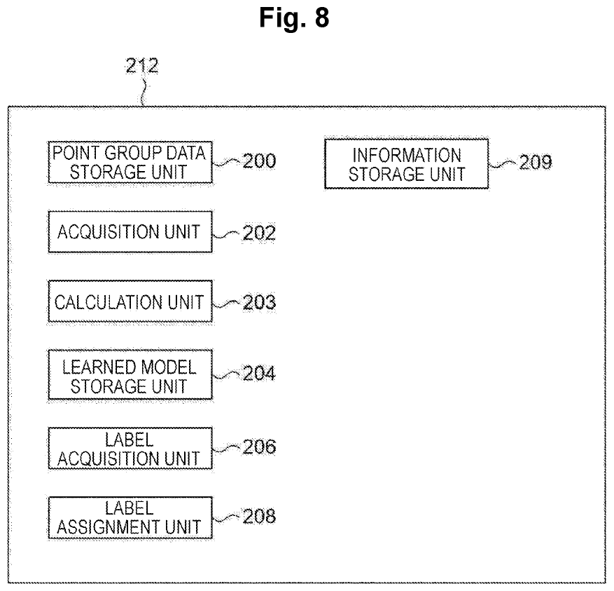

FIG. 8 is a block diagram showing an example of a functional configuration of an identification device 212 according to the second embodiment.

As illustrated in FIG. 8, the identification device 212 includes the point group data storage unit 200, the acquisition unit 202, the calculation unit 203, the learned model storage unit 204, the label acquisition unit 206, the label assignment unit 208, and an information storage unit 209 as functional configurations. Each functional configuration is realized by the CPU 21 reading an identification program stored in the ROM 22 or the storage 24, developing the identification program in the RAM 23, and executing the identification program.

The information storage unit 209 stores the set F′ of the second feature quantities and the set L of the class labels output from the learned DNN module M2 for each of the plurality of identification target points computed in advance by the identification device 20 of the first embodiment. Based on the set F′ of the second feature quantities and the set L of the class labels, the class labels for all the target points included in the target point group are generated.

The acquisition unit 202 acquires the target point from the point group data storage unit 200. Note that the target point is a three-dimensional point different from the identification target point and the neighboring point thereof.

The calculation unit 203 calculates the relative coordinates T_ij with respect to each of the identification target points, for each of the plurality of target points acquired by the acquisition unit 202. Note that the set T_j of relative coordinates is an array having D×Q elements.

The learned model storage unit 204 stores the class label assigning learned model learned by the learning device 10 of the first embodiment. Note that the class label assigning learned model includes the learned DNN module M1, the learned DNN module M2, and the learned DNN module M3, as in the first embodiment.

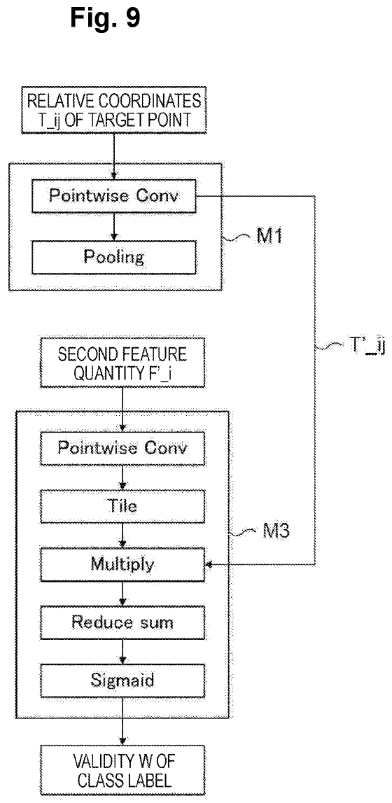

FIG. 9 illustrates a configuration of a model used in the second embodiment. As illustrated in FIG. 9, in the second embodiment, the relative coordinates T_ij of the target point are input into the learned DNN module M1. When the relative coordinates T_ij of the target point is input into the learned DNN module M1, the conversion coordinates T′_ij obtained by converting the relative coordinates T_ij of the target point is output from the learned DNN module M1. Note that the conversion coordinates T′_ij is an array having D′ elements. As shown in FIG. 9, the conversion coordinates T′_ij are input into the learned DNN module M3.

Furthermore, at that time, the second feature quantity F′_i stored in the information storage unit 209 is input into the learned DNN module M3. The second feature quantity F′_i is an array having C_2 elements. Note that C_ 2 is the number of dimensions of the vector of the feature quantity itself.

The second feature quantity F′_i represents the feature of the identification target point. Validity W_ij of the class label is calculated based on the second feature quantity F′_i and the relative coordinates T_ij of the target point. Note that the configurations of the layers of the learned DNN module M1 and the learned DNN module M3 may be appropriately changed. For example, when the first feature quantity F_i of the identification target point is not input from the model M1 into the model M2, the layer of pooling of the learned DNN module M1 may be deleted. Alternatively, the layer of tile of the learned DNN module M3 may be appropriately changed to correspond to the shape of the input data when parallel processing is performed.

The label acquisition unit 206 inputs the relative coordinates T_ij of the target point calculated by the calculation unit 203 to the learned DNN module M1 among the class label assigning learned models stored in the learned model storage unit 106. In the second embodiment, since each target point can be processed independently, processing per one target point will be described below. Note that a plurality of target points can be processed in parallel according to the performance of the computer.

Note that, at this time, the label acquisition unit 206 reads the second feature quantity F′_i stored in the information storage unit 209, and inputs the read second feature quantity F′_i into the learned DNN module M3 among the class label assigning learned model, thereby acquiring the validity W_ij of the class label of the target point. Here, W_ij is a scalar value. The set W_j of the validity of the class label of the target point indicates which class label is appropriately assigned from the set L of the class labels of the plurality of identification target points. The set of validity W_j of the class label is an array having 1×Q elements.

The label assignment unit 208 refers to the set L of class labels stored in the information storage unit 209, and sets the class label of the identification target point of which the validity W_ij of the class label is equal to or greater than a predetermined threshold value as a candidate class label assigned to the target point. Then, the label assignment unit 208 assigns the class label of the identification target point having the highest validity W_ij of the class label to the target point, and outputs the result as an identification result. In a case that the threshold value is set, the class label may not be assigned when the validity W_ij of the class label at all the identification target points is less than the threshold value. In addition, the class label L_i for each identification target point is an array having 1×U elements. U is the total number of identification target classes.

As described above, according to the second embodiment, it is possible to assign the class labels to all the target points by using the class labels and the feature quantities for the identification target points assigned in the first embodiment.

The learning processing or the identification processing executed by the CPU reading software (program) in each of the above embodiments may be executed by various processors other than the CPU. Examples of the processor in this case include a programmable logic device (PLD) in which a circuit configuration can be changed after manufacturing such as a field-programmable gate array (FPGA), and a dedicated electric circuit that is a processor having a circuit configuration exclusively designed for executing specific processing, such as an application specific integrated circuit (ASIC). In addition, the learning processing or the identification processing may be executed by one of these various processors, or may be performed by a combination of two or more processors of the same type or different types (for example, a plurality of FPGAs, a combination of a CPU and an FPGA, and the like). The hardware structure of these various processors is, more specifically, an electric circuit in which circuit elements such as semiconductor elements are combined.

In each of the above embodiments, the aspect in which the learning and identification program is stored (installed) in advance in the storage has been described, but the present invention is not limited thereto. The program may be provided in a form stored in a non-transitory storage medium such as a compact disk read only memory (CD-ROM), a digital versatile disk read only memory (DVD-ROM), and a universal serial bus (USB) memory. The program may be downloaded from an external device via a network.

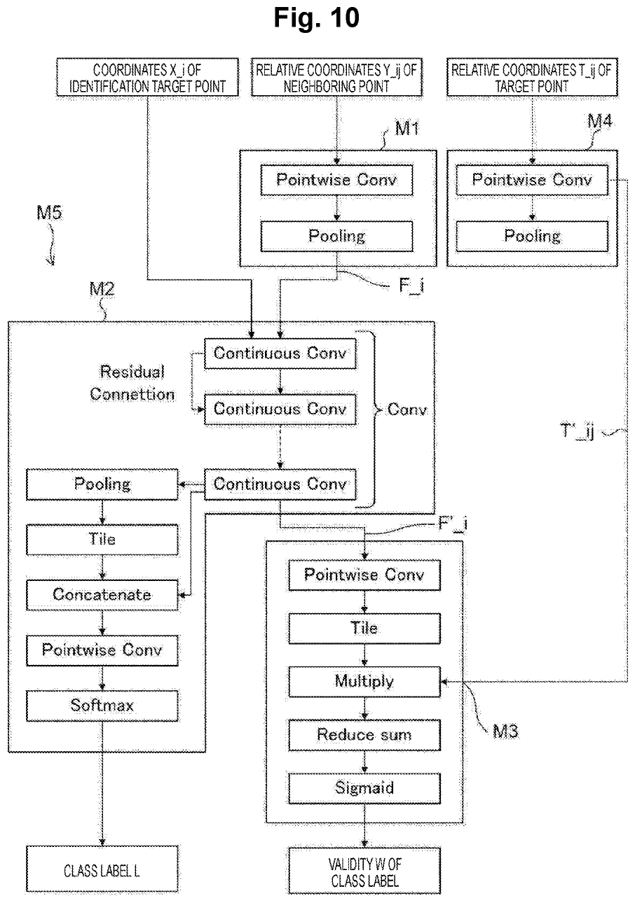

Furthermore, in the second embodiment, a case where the set F′ of the second feature quantities and the set L of the class labels output from the learned DNN module M2 learned in advance in the first embodiment are used, and the identification target point is not input into the class label assigning learned model has been described as an example, but the present invention is not limited thereto. For example, a class label assigning model M5 as illustrated in FIG. 10 may be learned, and class labels may be assigned to all the target points based on the model M5. In this case, the first feature quantity F_i of the identification target point is extracted from the relative coordinates of the neighboring points of the coordinates X_i of the identification target point by using the model M1, and the class label is assigned to the identification target point based on the extracted first feature quantity F_i. Note that the model M4 in FIG. 10 is a model similar to the model M1 of the first embodiment, and performs coordinate conversion from the relative coordinates T_ij to the conversion coordinates T′_ij by using the same DNN parameters as those of the model M1.

Furthermore, in the above embodiment, a case where the DNN module M3 computes the validity V_ij of the class label according to the above Formula (4) has been described as an example, but the present invention is not limited thereto. Any mathematical formula may be used to compute the validity V_ij of the class label.

Further, in the above embodiment, a case where the class label assigning model is learned to minimize the loss function Loss indicated in the above Formula (5) has been described as an example, but the present invention is not limited thereto. For example, the class label assigning model may be learned to maximize a predetermined function according to a deviation between the set L of class labels of learning identification target points and the set Lt of teacher data and a deviation between the set V of validity of the set L of class labels of learning neighboring points and the set Vt of teacher data thereof.

With regard to the above embodiments, the following supplementary notes are further disclosed.

### Supplementary Note 1

A learning device including
a memory and
at least one processor connected to the memory, in which
the processor is configured to
acquire learning data in which coordinates of a learning identification target point sampled from a learning target point group that is a set of three-dimensional target points for learning, relative coordinates of a learning neighboring point set for the learning identification target point with respect to the identification target point, teacher data of a class label of the learning identification target point, and teacher data of validity of the class label of the learning identification target point are associated with each other, and
learn a class label assigning model including a first model for inputting the relative coordinates of the neighboring point set for the identification target point with respect to the identification target point and outputting conversion coordinates obtained by converting the relative coordinates of the neighboring point and a first feature quantity, a second model for inputting the coordinates of the identification target point and the first feature quantity and outputting a second feature quantity and the class label of the identification target point, and a third model for inputting the second feature quantity and the conversion coordinates obtained by converting the relative coordinates of the neighboring point and outputting validity of the class label for the neighboring point, based on the learning data acquired by the learning data acquisition unit, to generate a class label assigning learned model for inputting the coordinates of the identification target point and the relative coordinates of the neighboring point and outputting the validity of the class label of the identification target point and the class label for the neighboring point.

### Supplementary Note 2

A non-transitory storage medium that stores a program executable by a computer to execute learning processing, in which
the learning processing includes
acquiring learning data in which coordinates of a learning identification target point sampled from a learning target point group that is a set of three-dimensional target points for learning, relative coordinates of a learning neighboring point set for the learning identification target point with respect to the identification target point, teacher data of a class label of the learning identification target point, and teacher data of validity of the class label of the learning identification target point are associated with each other, and
learning a class label assigning model including a first model for inputting the relative coordinates of the neighboring point set for the identification target point with respect to the identification target point and outputting conversion coordinates obtained by converting the relative coordinates of the neighboring point and a first feature quantity, a second model for inputting the coordinates of the identification target point and the first feature quantity and outputting a second feature quantity and the class label of the identification target point, and a third model for inputting the second feature quantity and the conversion coordinates obtained by converting the relative coordinates of the neighboring point and outputting validity of the class label for the neighboring point, based on the learning data acquired by the learning data acquisition unit, to generate a class label assigning learned model for inputting the coordinates of the identification target point and the relative coordinates of the neighboring point and outputting the validity of the class label of the identification target point and the class label for the neighboring point.

### Reference Signs List

10 Learning device
12, 212 Identification device
100 Learning point group data storage unit
102 Learning data acquisition unit
104 Learning unit
106, 204 Learned model storage unit
200 Point group data storage unit
202 Acquisition unit
203 Calculation unit
206 Label acquisition unit
208 Label assignment unit
209 Information storage unit

1. A learning device comprising a processor configured to execute operations comprising:
acquiring learning data, wherein the learning data includes at least:
first data including coordinates of a learning identification target point sampled from a plurality of learning target points expressed as a set of three-dimensional target points for learning,
second data including relative coordinates of a plurality of learning neighboring points associated with the learning identification target point relative to the learning identification target point,
third data including teacher data of a class label of the learning identification target point, and
fourth data including teacher data of validity of the class label of the learning identification target point; and
learning, based on the learning data, a class label assigning model, wherein the class label assigning model includes:
a first model, wherein the first model receives the second data including the relative coordinates of the plurality of neighboring points relative to the learning identification target point and outputs conversion coordinates and a first feature quantity, the conversion coordinates are obtained by converting the relative coordinates of the learning neighboring points,
a second model, wherein the second model receives the first data including the coordinates of the learning identification target point and the first feature quantity as input and outputs a second feature quantity and the third data including the class label of the learning identification target point, and
a third model, wherein the third model receives the second feature quantity and the conversion coordinates and outputs validity data indicating validity of respective class labels of the plurality of learning neighboring points, wherein the conversion coordinates are obtained by converting the relative coordinates of the neighboring point.

2. The learning device according to claim 1, wherein:
the learning further comprises learning the class label by either minimizing or maximizing a function and generating a learnt class label assigning model using the learning data corresponding to each of a plurality of the learning identification target points,
wherein the function is based at least on:
a deviation between the class label and the teacher data, wherein the class label is associated with the learning identification target point output from the class label assigning model during learning or before learning, and the teacher data represents a correct answer value of the class label of the learning identification target point, and
a deviation between the validity of the class label and the teacher data, wherein the class label is associated with the learning neighboring point output from the class label assigning model during learning or before learning, and the teacher data represents a correct answer value of the validity of the class label of the learning neighboring point.

3. An identification device comprising a processor configured to execute operations comprising:
acquiring a plurality of identification target points by sampling a target point group that is a set of three-dimensional target points;
calculating relative coordinates of a neighboring point that is a target point set for the identification target point with respect to the identification target point, for each of the plurality of identification target points;
acquiring class labels of the plurality of identification target points and validity of the class labels of each of the plurality of identification target points with respect to the neighboring points by inputting coordinates of the plurality of identification target points and the relative coordinates of the neighboring points with respect to each of the plurality of identification target points into the class label assigning learned model; and
assigning the class label acquired by the label acquisition unit to the plurality of identification target points, assigns the class labels to the neighboring points for each of the plurality of identification target points when the validity of the class label is included in a range determined by a predetermined threshold value, and identifies the class labels of the identification target points and the neighboring points.

4. The identification device according to claim 3, wherein
the class label assigning learned model includes a learned first model, a learned second model, and a learned third model, the learned third model, based on conversion coordinates obtained by converting the relative coordinates of the neighboring point output from the learned first model and a second feature quantity output from the learned second model, outputs validity of the class labels for the neighboring points for each of the plurality of identification target points according to a function, and wherein the function outputs a value according to a degree of possibility of the same class label being assigned to the identification target point and the neighboring point.

5. The identification device according to claim 3, wherein
the acquiring class labels further comprises:
inputting the relative coordinates with respect to the identification target points of the target points for each of the plurality of identification target points into the learned first model among the class label assigning learned models,
reading the second feature quantity from an information storage unit that stores the second feature quantity and the class label output from the learned second model when the coordinates of the identification target point and the relative coordinates of the neighboring point with respect to the identification target point for each of the plurality of identification target points are input into the class label assigning learned model, and
acquiring validity of a class label of the target point by inputting the read second feature quantity and the conversion coordinates into the learned third model among the class label assigning learned models, and
wherein the assigning the class label further comprises:
referencing the class label, and
assigning the class label of the identification target point, of which the validity of the class label is included in the range determined by the predetermined threshold value, to the target point to identify the class label of the target point.

6. A computer implemented method for learning, comprising:
acquiring learning data, wherein the learning data includes at least:
first data including coordinates of a learning identification target point sampled from a learning target points expressed as a set of three-dimensional target points for learning,
second data including relative coordinates of a plurality of learning neighboring points associated with the learning identification target point relative to to the learning identification target point,
third data including teacher data of a class label of the learning identification target point, and
fourth data including teacher data of validity of the class label of the learning identification target point are associated with each other; and
learning, based on the learning data, a class label assigning model, wherein the class label assigning model includes:
a first model, wherein the first model receives the second data including the relative coordinates of the plurality of neighboring points relative to the learning identification target point and outputs conversion coordinates and a first feature quantity, the conversion coordinates are obtained by converting the relative coordinates of the learning neighboring points,
a second model, wherein the second model receives the first data including the coordinates of the learning identification target point and the first feature quantity as input and outputs a second feature quantity and the third data including the class label of the learning identification target point, and
a third model, wherein the third model receives the second feature quantity and the conversion coordinates and outputs validity data indicating validity of respective class labels of the plurality of learning neighboring points, wherein the conversion coordinates are obtained by converting the relative coordinates of the neighboring point.

7-9. (canceled)

10. The computer implemented method according to claim 6, wherein:
the learning further comprises learning the class label by either minimizing or maximizing a function and generating a learnt class label assigning model using the learning data corresponding to each of a plurality of the learning identification target points,
wherein the function is based at least on:
a deviation between the class label and the teacher data, wherein the class label is associated with the learning identification target point output from the class label assigning model during learning or before learning, and the teacher data represents a correct answer value of the class label of the learning identification target point, and
a deviation between the validity of the class label and the teacher data, wherein the class label is associated with] the learning neighboring point output from the class label assigning model during learning or before learning, and the teacher data represents a correct answer value of the validity of the class label of the learning neighboring point.
